(19) United States
(12) Patent Application Publication
(10) Pub. No.: US 2022/0379188 A1
(43) Pub. Date: Dec. 1, 2022

(54) TREADMILL WITH SAFETY WARNING FUNCTION

(71) Applicant: REXON INDUSTRIAL CORP., LTD., Taichung (TW)

(72) Inventor: Ssu Shun YANG, Taichung (TW)

(21) Appl. No.: 17/824,326

(22) Filed: May 25, 2022

(30) Foreign Application Priority Data
May 25, 2021 (TW) 110118900

(51) Int. Cl. A63B 71/00; G08B 21/02; G08B 7/06; A63B 22/02; A63B 24/00; A63B 71/06

(52) U.S. Cl. CPC A63B 71/0054; G08B 21/02; G08B 7/06; A63B 22/025; A63B 24/0087; A63B 71/0622; A63B 2220/833

(57) ABSTRACT

A treadmill with safety warning function adapted for a runner to stand and run on, and to detect an object located behind the treadmill. The treadmill includes a running member, a sensor unit, a warning unit and a control unit. The running member includes a pair of side rails and a running belt. The sensor unit includes two sensors which detect toward a rear of the treadmill. Signals of the control unit are connected to the driving unit, the sensor unit and the warning unit. The control unit can determine whether there is an object within a predetermined distance behind the running member based on the detected information of the sensors and further controls the warning unit to send out a first warning when an object is detected. Accordingly, the present invention can detect the object behind the treadmill and remind the runner to enhance user safety.

### BACKGROUND OF THE INVENTION

### 1. Technical Field

The present invention is related to an exercise equipment, and in particular, to a treadmill with a safety warning function.

### 2. Description of Related Art

As people value heath more seriously nowadays, a lot of people install a treadmill at their own homes, such that they are able to use the treadmill to perform exercise at home regardless of the outdoor weather condition.

However, in comparison to a gym, the home environment is relatively more complicated to ensure safe operation and use of the equipment. When a runner performs exercise on a treadmill, his or her eyes tend to face toward the front, such that when there a pet, child or other object, such as ball or toy, that approaches the treadmill, the runner is often unaware of such object at the rear of the treadmill. Consequently, the approaching pet, child or other object may be caught by the running belt on the treadmill, resulting in injury or damage.

### BRIEF SUMMARY OF THE INVENTION

Accordingly, an objective of the present invention is to provide a treadmill with a safety warning function capable of detecting an object at a rear of the treadmill and to notify the runner.

To achieve the objective, the present invention provides a treadmill with a safety warning function, capable of allowing a runner to stand and run thereon and detecting an object located at or approaching a rear thereof. The treadmill with a safety warning function comprises a running unit, a driving unit, a detection unit, a warning unit and a control unit.

The running unit comprises a base, two side rails arranged spaced apart from each other and extending rearward from the base, a driving roller and a driven roller pivotally installed between the side rails, and a running belt arranged between the side rails and mounted on the driving roller and the driven roller and provided for the runner to stand and thereon. A front-rear direction is defined along an extension direction of each one of the side rails. Each one of the side rails includes a rear section protruding out of a rear side of the running belt.

The driving unit is arranged on the base and is configured to drive the driving roller to rotate in order to drive the running belt to rotate around the driving roller and the driven roller, thereby allowing the runner to run forward along the front-rear direction on the running belt. The detection unit comprises two detectors arranged at the rear sections and are provided to detect a detection range at a rear respectively, and each detector is configured to generate a detection information. The warning unit is configured to generate a first warning notification.

The control unit is electrically connected to the driving unit, the detection unit and the warning unit for transmitting signals. The control unit is configured to determine whether the object is within a predefined distance range at a rear of the running unit based on the detection information detected by the detectors, and to control the warning unit to generate the first warning notification upon detection of the object.

The technical effects of the present invention include the following. The control unit is able to determine whether the object is within a predefined distance range at a rear of the running unit based on the detection information detected by the detectors, and is able to control the warning unit to generate the first warning notification upon detection of the object. Accordingly, a foreign object may be detected at the rear of the treadmill, and the runner notified to make a necessary response.

### BRIEF DESCRIPTION OF THE SEVERAL VIEWS OF THE DRAWINGS

Other features and technical effects of the present invention will be illustrated clearly in the accompanied drawings and the embodiments as follows:

FIG. 1 is a perspective view of an embodiment of the treadmill with a safety warning function of the present invention;

FIG. 2 is a top view of the embodiment of the present invention; and

FIG. 3 is a system block diagram of the embodiment of the present invention.

### DETAILED DESCRIPTION OF THE INVENTION

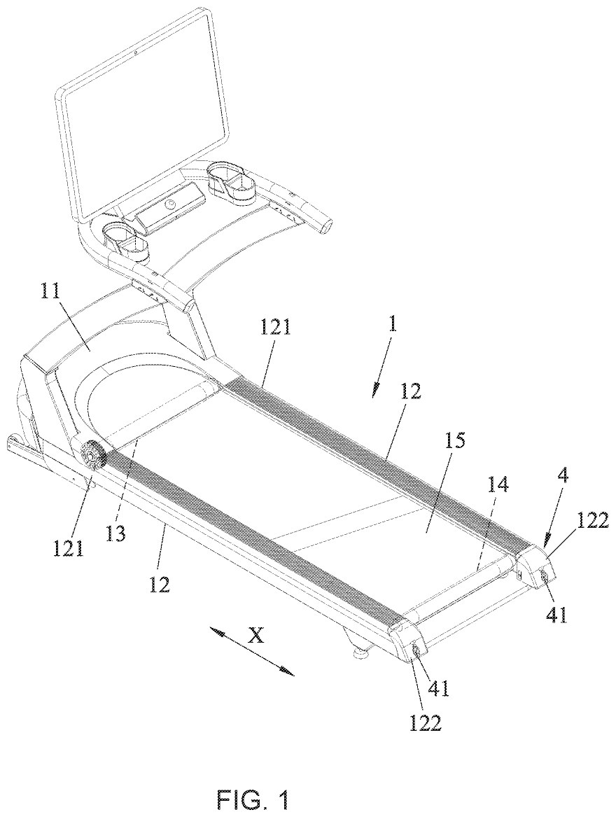

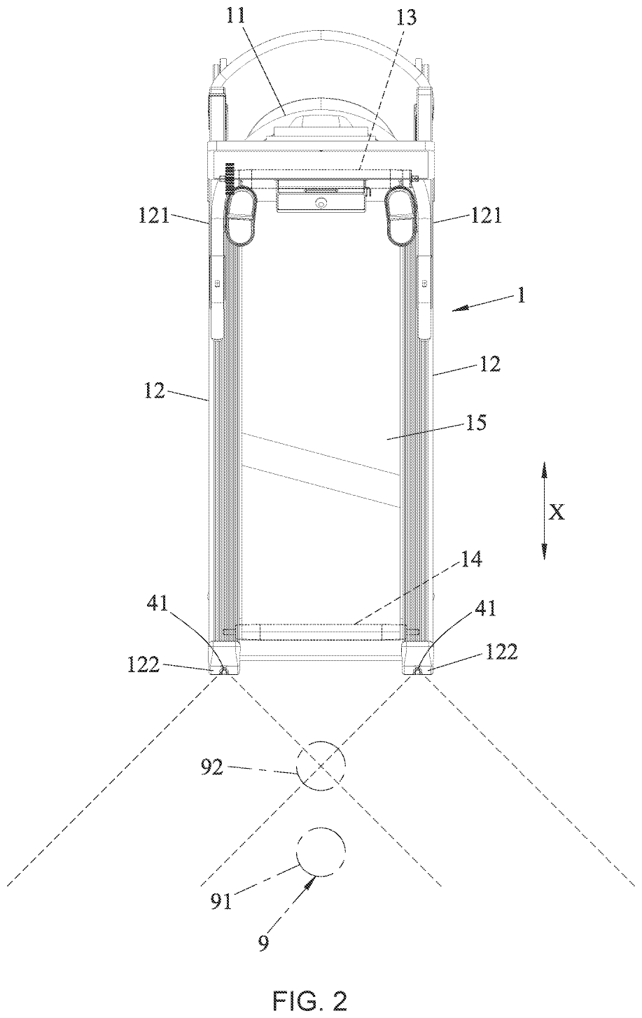

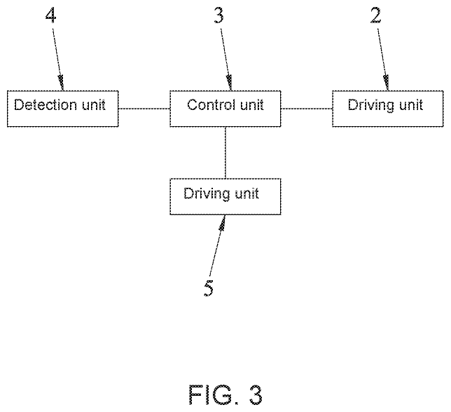

As shown in FIG. 1 to FIG. 3, an embodiment of a treadmill with a safety warning function of the present invention is illustrated, and it is capable of allowing a runner (not shown in the drawings) to stand and run thereon and of detecting an object 9 (an object 9 at two positions 91, 92 is shown in FIG. 2) located at a rear thereof. The treadmill with a safety warning function comprises a running unit 1, a driving unit 2, a detection unit 4, a warning unit 5 and a control unit 3.

The running unit 1 comprises a base 11, two side rails 12 arranged spaced apart from each other and extending rearward from the base 11, a driving roller 13 and a driven roller 14 pivotally installed between the side rails 12, and a running belt 15 arranged between the side rails 12 and mounted on the driving roller 13 and the driven roller 14 and provided for the runner to stand and run thereon. A front-rear direction X is defined along an extension direction of each one of the side rails 12. Each one of the side rails 12 includes a front section 121 connected to the base 11, and a rear section 122 opposite from the front section 121 and protruding out of a rear side of the running belt 15. In this embodiment, the driving roller 13 is located at the front side, and the driven roller 14 is located at the rear side; however, the present invention is not limited to such configuration only.

The driving unit 2 is arranged on the base 11 and is configured to drive the driving roller 13 to rotate in order to drive the running belt 15 to rotate around the driving roller 13 and the driven roller 14, thereby allowing the runner to run forward along the front-rear direction X on the running belt 15.

The detection unit 4 comprises two detectors 41 arranged at the rear sections 122 and provided to detect a detection range at a rear respectively, wherein each detector 41 is configured to generate a detection information.

In this embodiment, each detector 41 is an ultrasonic distance detector. The detection ranges of the detectors 41 of the detection unit are at least partially overlapped with each other, such that an overlapping portion is correspondingly located at a rear center of the running belt 15.

The warning unit 5 is configured to generate a first warning notification and second warning notification. The first warning notification of the warning unit is selected from a group consisting of a sound, an image, a light and a combination thereof. The second warning notification of the warning unit is selected from a group consisting of a sound, an image, a light and a combination thereof.

The control unit 3 is electrically connected to the driving unit 2, the detection unit 4 and the warning unit 5 for transmitting signals.

The control unit 3 is configured to determine whether an object 9 is within a predefined distance range at a rear of the running unit 1 based on the detection information detected by the detectors 41, and to control the warning unit 5 to generate the first warning notification upon detection of the object 9. In this embodiment, when the control unit 3 controls the warning unit 5 to generate the first warning notification, it is able to synchronously control the driving unit 2 and to control a rotating speed of the driving roller 13, thereby reducing the rotating speed of the driving roller 13 and stopping it gradually.

The control unit 3 is configured to further determine whether the object 9, located within the predefined distance range, moves toward the running unit 1, based on the detection information detected by the detectors 41, and to control the warning unit 5 to generate a second warning notification when the object 9 moves in a direction toward the running unit 1. In this embodiment, when the control unit 3 controls the warning unit 5 to generate the second warning notification, it is able to synchronously control the driving unit 2 and to control the driving roller 13 to stop rotation.

When the runner performs exercise and run on the treadmill with a safety function, the detectors 41 are able to perform detection toward the rear of the treadmill. When the control unit 3 determines that the object 9 is within the predefined distance range at the rear of the running unit 1 based on the detection information detected by the detectors 41, the warning unit 5 is able to generate the first warning notification in order to notify the runner to make necessary response. In addition, when the control unit 3 controls the warning unit 5 to generate the first warning notification, it is also able to synchronously control the driving unit 2 and to control the rotating speed of the driving roller 13, in order to reduce the rotating speed of the driving roller 13 and to stop it gradually, thereby preventing the nearby object 9 at an overly close distance from being caught by the treadmill with a safety warning function.

Furthermore, when the control unit 3 determines that the object 9 located within the predefined distance range moves toward the direction of the running unit 1 based on the detection information detected by the detectors 41, the warning unit 5 is able to generate the second warning notification in order to notify the runner of the emergency situation. In addition, when the control unit 3 controls the warning unit 5 to generate the second warning notification, it is also able to synchronously control the driving unit 2 and to control the driving roller 13 to stop its rotation. Accordingly, if the object 9 continues to move in the direction toward the running unit 1, it can be prevented from being caught by the treadmill with a safety warning function.

It shall be noted that with regard to the analysis techniques for determining whether the object 9 is within the predefined distance range at the rear of the running unit 1 and whether the object 9 moves in the direction toward the running unit 1, in this embodiment, analysis and computation are performed through the return wave time of the ultrasonic wave of the detectors 41. FIG. 2 is used as an example for illustration. When the object 9 is located at the position 91, the detectors 41 are able to detect that the return wave time is relatively longer as the object 9 is at a farther distance, and the detectors 41 are able to detect that the return wave time is relatively shorter as the object 9 is at a closer distance. As a result, through the analysis on the return wave time of the detectors 41, it is able to determine whether the object 9 is within the predefined distance range. In addition, as the return wave time is further analyzed, it is able to determine whether the object 9 moves in the direction toward the running unit 1.

Moreover, in addition to the sound wave detection technique, the detectors 41 can also utilize a light wave detection technique, such as proximity sensors. Furthermore, each detector 41 can also be a wide-angle, and the image recognition technique can be utilized to analyze the distance between the object 9 and the running unit 1.

It shall be noted that since the first warning notification and second warning notification can be different notification types; for example, the first warning notification can be a sound notification, and the second warning notification can be a sound and light notification. In another embodiment, the first warning notification and the second warning notification can be of the same notification type but different contents; for example, the first warning notification and the second warning notification can both be sound notification but have different sound durations. Furthermore, in still another embodiment, the notification type and the notification content can be changed according to the distance between the object 9 and the running unit 1, such that the runner is able to distinguish whether the object 9 is located within the predefined range distance, moving in the direction toward the running unit 1 or located at a very close distance to the running unit 1, in order to determine the corresponding emergency level.

In view of the above, for the treadmill with a safety function of the present invention, the control unit 3 is able to analyze whether the object 9 is within a predefined distance range at a rear of the running unit 1 based on the detection information detected by the detectors 41, and is able to control the warning unit 5 to generate the first warning notification upon detection of the object 9. Accordingly, it is able to detect a foreign object at the rear of the treadmill and to notify the runner to make necessary response, thereby achieving the objectives of the present invention.

It shall be understood that the above description is provided to illustrate the possible embodiments of the present invention only, and it shall not be treated as limitation to the implementation scope of the present invention. All mere and equivalent changes and modifications made based on the scope of the claims and the content of the specification of the present invention shall be considered to be within the scope of the claims of the present invention.

What is claimed is:

1. A treadmill with a safety warning function, capable of allowing a runner to stand thereon and detecting an object located at a rear thereof, the treadmill having a safety waning function comprising:
a running unit comprising a base, two side rails arranged spaced apart from each other and extending rearward from the base, a driving roller and a driven roller pivotally installed between the side rails, and a running belt arranged between the side rails and mounted on the driving roller and the driven roller and provided for the runner to stand and run thereon, a front-rear direction defined along an extension direction of each one of the side rails, and each one of the side rails having a rear section protruding out of a rear side of the running belt;
a driving unit arranged on the base and configured to drive the driving roller to rotate in order to drive the running belt to rotate around the driving roller and the driven roller, thereby allowing the runner to run forward along the front-rear direction on the running belt;
a detection unit comprising two detectors arranged at the rear sections and provided to detect a detection range at a rear respectively, and each detector configured to generate a detection information;
a warning unit configured to generate a first warning notification; and
a control unit electrically connected to the driving unit, the detection unit and the warning unit for transmitting signals; the control unit configured to determine whether the object is within a predefined distance range at a rear of the running unit based on the detection information detected by the detectors, and to control the warning unit to generate the first warning notification upon detection of the object.

2. The treadmill with a safety warning function according to claim 1, wherein the detection ranges of the detectors of the detection unit are at least partially overlapped with each other, such that an overlapping portion is correspondingly located at a rear center of the running belt.

3. The treadmill with a safety warning function according to claim 2, wherein the control unit is configured to further determine whether the object located within the predefined distance range moves toward the running unit based on the detection information detected by the detectors, and to control the warning unit to generate a second warning notification when the object moves in a direction toward the running unit.

4. The treadmill with a safety warning function according to claim 2, wherein when the control unit controls the warning unit to generate the first warning notification, the control unit is able to synchronously control the driving unit and to control a rotating speed of the driving roller.

5. The treadmill with a safety warning function according to claim 3, wherein when the control unit controls the warning unit to generate the second warning notification, the control unit is able to synchronously control the driving unit and to control the driving roller to stop rotation.

6. The treadmill with a safety warning function according to claim 1, wherein the first warning notification of the warning unit is selected from a group consisting of a sound, an image, a light and a combination thereof.

7. The treadmill with a safety warning function according to claim 3, wherein the second warning notification of the warning unit is selected from a group consisting of a sound, an image, a light and a combination thereof.

8. The treadmill with a safety warning function according to claim 1, wherein the detectors of the detection unit use one of a sound wave and a light wave to perform detection.
